(19) United States
(12) Patent Application Publication
(10) Pub. No.: US 2007/0184401 A1
(43) Pub. Date: Aug. 9, 2007

(54) Dental hygiene device & teeth polishing method

(76) Inventor: Gina Dellanina, Irvine, CA (US)

Correspondence Address: CONNORS ASSOCIATES, 1600 DOVE ST, SUITE 220, NEWPORT BEACH, CA, 92660, US

(21) Appl. No.: 11/527,328

(22) Filed: Sep. 26, 2006

Related U.S. Application Data
(63) Continuation-in-part of application No. 10/757,362, filed on Jan. 14, 2004, now Pat. No. 7,114,950.
(60) Provisional application No. 60/440,134, filed on Jan. 15, 2003.

(51) Int. Cl. A61C 19/00; A61C 3/00; A61C 17/06

(52) U.S. Cl. 433/25; 433/163; 433/91

(57) ABSTRACT

A dental hygiene device comprises a cup member including an attachment member that enables the device to be attached and detached to a suction tube adapted to be inserted into the mouth of a patient during treatment of the patient's teeth. The cup member holds a dental material used in connection with the treatment that is accessed by a dental hygienist during treatment of a patient's teeth.

### RELATED PATENT APPLICATIONS & INCORPORATION BY REFERENCE

This application is a continuation-in-part of utility patent application U.S. application Ser. No. 10/757,362, filed Jan. 14, 2004, now U.S. Pat. No. 7,114,950, which claims the benefit under 35 USC 119(e) of U.S. provisional patent Application No. 60/440,134, entitled “Prophy Cup Attachment,” filed Jan. 15, 2003. These related applications are incorporated herein by reference and made a part of this application. If any conflict arises between the disclosure of the invention in this continuation-in-part application and that in the related provisional or utility applications, the disclosure in this continuation-in-part application shall govern. Moreover, the inventor incorporates herein by reference any and all U.S. patents, U.S. patent applications, and other documents cited or referred to in this application.

### DEFINITIONS

The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

### BACKGROUND OF INVENTION

Polishing teeth is a common dental procedure wherein a polishing material is applied to a patient's teeth using an implement attached to the handpiece of a dental drill. The polishing implement, commonly referred to as a prophy angle, is periodically dipped into a container of polishing material to collect on the tip of the implement some of this material. The tip of the implement with the material thereon is then brought to bear against a tooth of the patient.

### SUMMARY OF INVENTION

This invention has one or more features as discussed subsequently herein. After reading the following section entitled “DETAILED DESCRIPTION OF SOME EMBODIMENTS OF THIS INVENTION,” one will understand how the features of this invention provide its benefits. The benefits of this invention include, but are not limited to: convenience of use, improved ergonomics for the user polishing teeth, reduction of saliva flow for a drier working environment, improved patient comfort, more effective use of polishing material, reduction in the time to polish teeth, low cost, and disposability or reusability.

Briefly, the dental hygiene device of this invention comprises a cup member that holds polishing or other dental material used during treatment of a tooth and an attachment member such as a clip incorporated into the cup member that attaches to a suction tube, commonly referred to as a saliva ejector in a dental operatory. The suction tube is placed in the patient's mouth at the time of polishing or otherwise using the dental material. The dental material may be placed directly into the cup member or it may be within a container that is placed in the cup member. After use the container may be discarded.

The invention also includes an assembly of the dental hygiene device of this invention and a short segment of a suction tube. This assembly provides a novel structure facilitating greater safety, utility and convenience for a dental worker. This unique assembly allows a dental worker to connect detachably one end of the tube to a source of suction and place an opposed free end into the mouth of the patient. The dental worker may withdraw periodically the free end from the patient's mouth and place the assembly on a clean field usually a disposable paper napkin or the like placed on the chest of the patient while seated in a substantially reclined position in a dental chair. The dental hygiene device is mounted on an intermediate portion of the tube segment and the cup inhibits inverting of the assembly when it is placed on the clean field on the chest of the reclining patient. When the dental treatment is complete, the one end of the tube segment is detached and the entire assembly may be discarded. If the dental hygiene device is of the type using dental material stored in a disposable container, it may be detached from the tube segment and reused after discarding the used container.

Without limiting the scope of this invention as expressed by the claims that follow, some, but not necessarily all, of its features are:

One, the dental hygiene device of this invention includes a cup member with a compartment holding a tooth polishing material and an attachment member that enables the device to be attached and detached to a suction tube adapted to be inserted into the mouth of a patient during polishing of the patient's teeth. The compartment may hold a sufficient amount of polishing material to polish the teeth of essentially only a single patient. The device may be molded from a plastic. The plastic may be heat resistance to withstand autoclaving so the device may be sterilized and reused. The cup member has an open top covered with a removable seal and a closed bottom. The attachment member may project outwardly from the closed bottom.

Two, the attachment member may comprise a pair of finger elements of sufficient length and spaced apart a predetermined distance so that, upon inserting the tube between the finger elements, the device is held securely to the tube during polishing of the patient's teeth. The finger elements may be centrally located, are substantially parallel, and are substantially parallel to a longitudinal axis of the cup member. The finger elements may merge at a base member connected to the bottom and form an open bite having a substantially circular configuration having a diameter slightly less than a diameter of the suction tube. The finger elements may have inner edges tapering outward from the open bite to terminate at ends spaced apart a distance slightly greater than the diameter of the suction tube.

These features are not listed in any rank order nor is this list intended to be exhaustive.

This invention also includes a method polishing teeth. In accordance with the method of this invention a suction tube is placed into an open mouth of a patient, this tube having a dental hygiene device mounted on the tube nearby the open mouth and the dental hygiene device holds a tooth polishing material that is accessed periodically during polishing of the patient's teeth. Besides tooth polishing, essentially the same method may be used in connection with a wide variety of other dental materials used in connection with the treatment of a patient's teeth that is accessed periodically by a dental worker during treatment. Other dental materials such as, for example, filling composites, desensitizing or pain killing agents, such as for, example, PS2 Pain-Free, may by applied to a patient's teeth using the method of this invention. These materials may be powders, pastes, gels, semi-solids, emulsions, etc.

This invention saves time, decreases frustration of the dental worker using the invention, typically a dental hygienist, and helps keep an ideal dry environment for the user while providing the service of polishing the patient's teeth. While the user polishes the patient's teeth excess saliva can be produced which can decrease the effect of the polish and increase patient discomfort caused by pooling saliva in the patient's mouth (it is best to polish in an dry environment so the polishing material can effectively remove soft plaque etc. and clean the tooth surface). When employing the conventional polishing method or other treatment, the user has to stop several times to suction out the saliva to keep the mouth dry and the patient comfortable. That means stopping the polishing procedure or other treatment, putting down the polishing implement and the container of the polishing material, and picking up and placing the suction tube in the patient's mouth to remove the pooling saliva. This takes up time as well as gets messy for the patient and the user. Moreover, material is sometimes “spun-off” from the polishing implement as it is withdrawn from the patient's mouth, spattering or cross-contaminating other areas of the dental operatory. This invention avoids stopping polishing or other treatment in order to apply suction to keep the mouth dry and minimizes spattering. This enables the user to access to the polishing or other dental material while allowing suction to be used continuously so the mouth can stay dry, the patient can remain comfortable, and allows the user to save time and not be inconvenienced.

### DESCRIPTION OF DRAWING

Some embodiments of this invention, illustrating all its features, will now be discussed in detail. These embodiments depict the novel and non-obvious dental hygiene device and tooth treatment method of this invention as shown in the accompanying drawing, which is for illustrative purposes only. This drawing includes the following figures (Figs.), with like numerals indicating like parts:

FIG. 1 is a side elevational view of one embodiment of the dental hygiene device of this invention.

FIG. 1A is a cross-sectional view taken along line 1A-1A of FIG. 1.

FIG. 2 is a front elevational view of the dental hygiene device of this invention taken along line 2-2 of FIG. 1.

FIG. 3 is a cross-sectional view taken along line 3-3 of FIG. 2.

FIG. 4 is a perspective view illustrating using the one embodiment of the dental hygiene device of this invention shown in FIGS. 1 through 3.

FIG. 5 is a cross-sectional view taken along line 5-5 of FIG. 4.

FIG. 6 is a perspective view of an alternate embodiment of the dental hygiene device of this invention adapted to be used with a disposable container pre-filled with a polishing or other dental material and detachably connected to a suction tube segment.

FIG. 7 is an explode perspective view of the dental hygiene device shown in FIG. 6.

### DETAILED DESCRIPTION OF SOME EMBODIMENTS OF THIS INVENTION

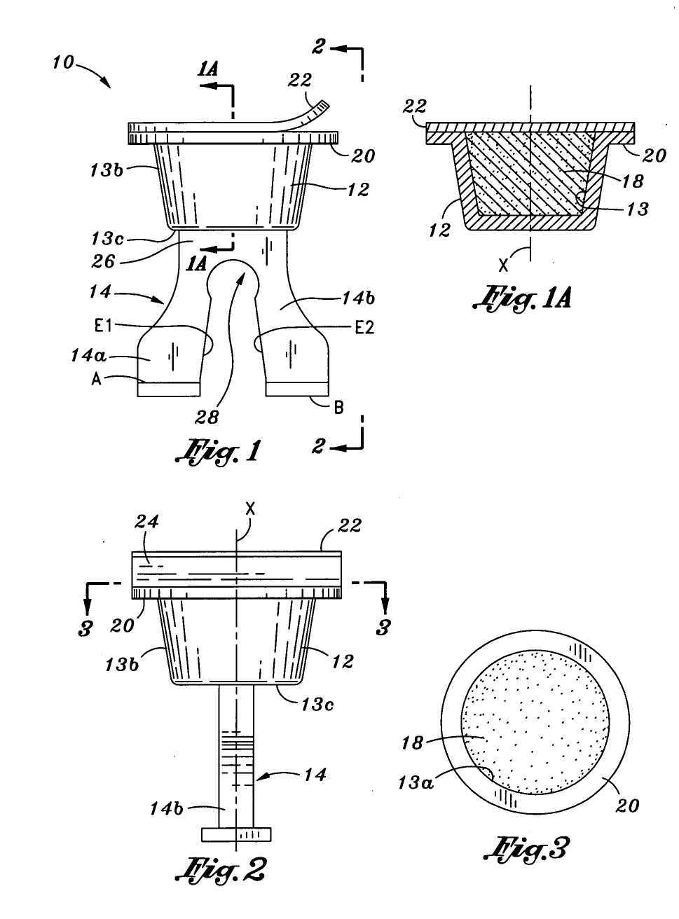

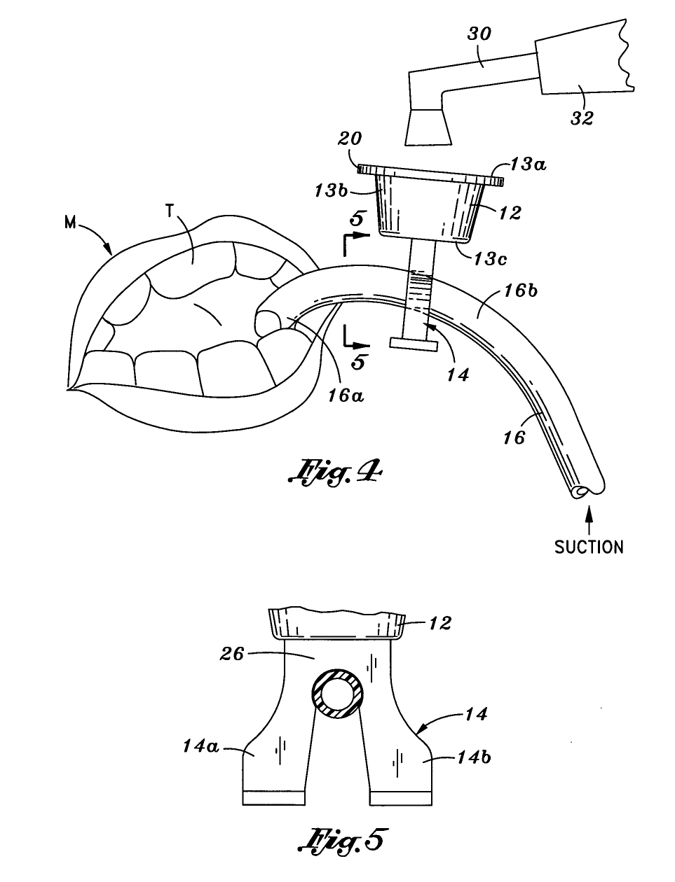

FIGS. 1 through 5

As depicted in FIGS. 1 through 3, one embodiment of this invention, the dental hygiene device 10, includes a cup member 12 having an attachment member 14 that enables the device to be attached and detached to a suction tube 16 (FIG. 4). This suction tube 16, the saliva ejector, is adapted to be inserted into the mouth M (FIG. 4) of a patient during polishing of the patient's teeth T. The cup member 12 holds within an internal compartment 13 (FIG. 1A) a tooth polishing material 18 such as, for example, Nupro® prophylaxis paste manufactured by DENTSPLY Preventive Care of York Pennsylvania. This polishing material 18 is a moist paste comprising an abrasive material including solid particulates. The device 10 may be molded from a plastic such as, for example polypropylene, to form a unitary structure with the cup member 12 and the attachment member 14 integrated as a single piece.

The compartment 13 is filled with a sufficient amount of polishing material 18 to polish the teeth T of essentially only a single patient. For example, in the embodiment illustrated the compartment 13 has the capacity to hold from about 0.05 to about 0.1 cubic inches of the tooth polishing material 18. This compartment 13 has an open top 13a, a substantially cylindrical side wall 13b, and a closed bottom 13c. The open top 13a has a substantially circular configuration and is at least partially encompassed by a rim 20 that projects outwardly from a side wall 13b of the cup member 12 at an angle of about 90° with respect to the longitudinal axis X of the cup member 12. A removable seal 22, shown partially removed, covers and seals the open top 13a and prevent access to the polishing material 18 until the user is ready to polish a patent's teeth. This seal may be a thin foil material with an adhesive 24 (FIG. 2) between the rim and perimeter of the seal fixing the seal 20 to the rim 20 until removed.

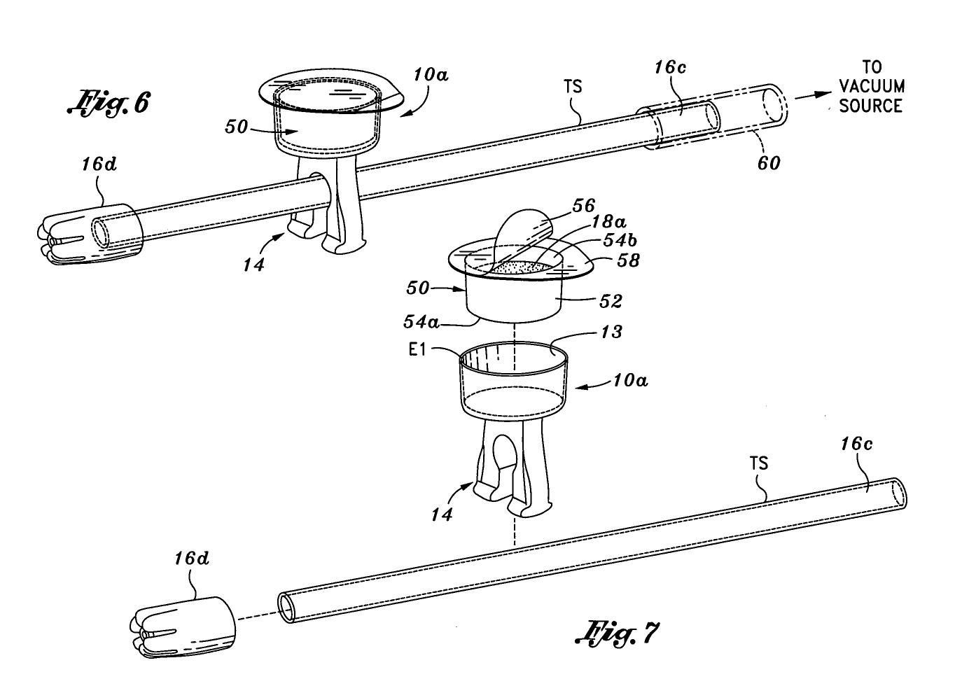

The attachment member 14 projects outwardly from the bottom wall 13c of the cup member 12 and it may be in the form of a clip configured to grasp the suction tube 16. The attachment member 14 may comprise a pair of fingers 14a and 14b. The fingers 14a and 14b are of sufficient length and spaced apart a predetermined distance so that upon inserting the suction tube 16 (FIG. 5) between the fingers the device 10 is held securely to the tube during polishing of the patient's teeth with the fingers straddling and grasping the tube. The fingers 14a and 14b are centrally located, are substantially parallel, and are substantially parallel to the longitudinal axis X of the cup member 12. These finger elements 14a and 14b merge at a base member 26 connected to the bottom wall 13c and form an open bite 28 (FIG. 1) having a substantially circular configuration having a diameter slightly less than the diameter of the suction tube 16, for example, the diameter of the open bite 28 may be substantially about 0.25 inch. The fingers 14a and 14b each have inner edges E1 and E2 tapering outward from the open bite 28 to terminate at ends A and B spaced apart a distance slightly greater than the diameter of the suction tube 16. The inner edges each tapers outward from the bottom wall 13c at an angle from about 1 to about 10° with respect to the longitudinal axis X of the cup member 12.

In accordance with the teeth polishing method of this invention the device 10 is attached to the suction tube 16 and then detached and disposed of after using. As best illustrated in FIG. 5, an end 16a of a suction tube 16 is placed into an open mouth M of a patient with an adjacent portion 16b of the tube extending from the open mouth. With the device 10 mounted on the adjacent portion 16b of the tube 16 by the attachment member 14, the cup member 12 is positioned on the tube 16 to enable access to the tooth polishing material 18 during polishing of the patient's teeth. A conventional disposable polishing implement 30 connected to a conventional dental handpiece 32 of a dental drill (not shown) is used to apply the polishing material 18 from the cup member 12 to the teeth T. A suitable polishing implement 30 is sold by DENTSPLY Preventive Care of York Pennsylvania identified as the prophy angle bearing the trademark Rite-Angle®. The patient's teeth T are polished while suction is concurrently being applied through the suction tube 16 to withdraw saliva from the patient's mouth. The polishing implement 30 is periodically inserted by the user into the tooth polishing material 18 to collect on the implement a portion of the material in the cup member 12. When all the patient's teeth are polished, the compartment 13 is essentially depleted of all the polishing material 18 and the device 10 is detached from the tube 16 and discarded, or as discussed subsequently reused.

FIGS. 6 and 7

The embodiment of this invention depicted in FIGS. 6 and 7 is generally designated by the numeral 10a and is essentially identical to the dental hygiene device 10 except the internal compartment 13 of the device 10a is not filled with a tooth polishing material 18 and the rim 20 of the cup member 12 has been eliminated to provide a circular edge El (FIG. 6) defining an access opening to the normally empty compartment 13. Instead, a container 50 holding a tooth polishing or other dental material 18a is used. This container 50 is placed in the compartment 13 when tooth treatment is to be performed. The device 10a may be connected directly to a suction tube 16 as discussed above or to a short tube segment TS that is detachably connected to a source of vacuum.

The container 50 may be of substantially cylindrical configuration with a slightly inwardly tapered sidewall 52 extending between a closed bottom wall 54a and an open top 54b covered by a removable lid 56 held to a rim 58 of the container by an adhesive, sealing the container until its contents, the tooth polishing material 18, is to be accessed during polishing. The external dimensions of the container 50 are substantially the same as the internal dimensions of the compartment 13 of the dental hygiene device 10a, for example, the diameter of the container 50 is approximately 0.55 inch and its depth is approximately 0.40 inch. Upon placing the container 50 within the compartment, the closed bottom wall 54a of the container 50 is adjacent the inside surface of the closed bottom 13c of the compartment 13 and the rim 58 of the container 50 rests on the edge El of the access opening into the compartment. Prior to placing in the compartment 13, the container 50 is pre-filled with a sufficient amount of polishing material 18 to polish the teeth T of essentially only a single patient and then sealed with the lid 56. After use, the empty container 50 is discarded and the device 10a may be reused after sterilizing, for example, by autoclaving. A new, sterile, and pre-filled container 50 is then placed in the device 10a after it is sterilized.

In accordance with another feature of this invention, either the device 10 or the device 10a may be mounted on a relatively short tube segment TS by clipping the attachment member 14 to an intermediate portion of the short tube segment prior to tooth treatment. The short tube segment TS has a length that does not exceed approximately 7 inches, and typically has a length substantially from 4 to 7 inches, nominally 5.75 inches. This short tube segment TS has its one end 16c inserted into a main suction tube 60 in communication with a vacuum source. Its other end 16d is inserted into a patient's mouth as discussed above during treatment of the teeth T. The dental hygiene device holding the dental material 18a, either the device 10 or the device 10a, is accessed periodically during treatment of the patient's teeth T. Subsequent to treatment the entire assembly of the short tube segment TS and attached dental hygiene device is discarded; however, if desired, the device 10a may be reused.

### SCOPE OF THE INVENTION

The above presents a description of the best mode contemplated of carrying out the present invention, and of the manner and process of making and using it, in such full, clear, concise, and exact terms as to enable any person skilled in the art to which it pertains to make and use this invention. This invention is, however, susceptible to modifications and alternate constructions from that discussed above which are fully equivalent. Consequently, it is not the intention to limit this invention to the particular embodiments disclosed. On the contrary, the intention is to cover all modifications and alternate constructions coming within the spirit and scope of the invention as generally expressed by the following claims, which particularly point out and distinctly claim the subject matter of the invention:

1. A method of polishing teeth where a suction tube is placed into an open mouth of a patient, said tube having a dental hygiene device mounted on the tube nearby the open mouth, said dental hygiene device holding a tooth polishing material that is accessed periodically during polishing of the patient's teeth, said tooth polishing material being within a container that is held by the device during polishing and then said container is discarded after polishing.

2. The method of claim 1 where the container is placed within a compartment of the device.

3. The method of claim 2 where the compartment of the dental hygiene device has predetermined internal dimensions and the container has external dimensions that are substantially the same as internal dimensions of said compartment.

4. A method of polishing teeth where one end of a tube segment is placed into an open mouth of a patient and an opposed end of the tube segment is placed in communication with a vacuum source, said tube segment having a dental hygiene device mounted thereon nearby said one end, said dental hygiene device holding a tooth polishing material that is accessed periodically during polishing of the patient's teeth, and subsequent to polishing teeth the assembly of the tube segment and attached dental hygiene device is discarded.

5. The method of claim 4 where said tooth polishing material is within a container that is held by the device during polishing and then said container is discarded after polishing.

6. The method of claim 5 where the container is placed within a compartment of the device.

7. The method of claim 6 where the compartment of the dental hygiene device has predetermined internal dimensions and the container has external dimensions that are substantially the same as internal dimensions of said compartment.

8. A disposable assembly of a tube and a dental hygiene device, wherein
said tube has a length that that does not exceed 7 inches and one end adapted to be inserted into a main suction tube in communication with a vacuum source and an opposed end 16d adapted to be inserted into a patient's mouth during polishing of the teeth,
said dental hygiene device being mounted on an intermediate portion of the tube between said ends and holding a tooth polishing material that is accessed periodically during polishing of the patient's teeth.

9. The disposable assembly of claim 8 where said tooth polishing material is within a container that is held by the device during polishing and then said container is discarded after polishing.

10. A method of treating teeth where a suction tube is placed into an open mouth of a patient, said tube having a dental hygiene device mounted on the tube nearby the open mouth, said dental hygiene device holding a dental material used in connection with said treatment that is accessed periodically during treatment of the patient's teeth.

11. The method of claim 10 where the dental hygiene device holds a container of the dental material and then said container is discarded after polishing.

12. The method of claim 11 where the dental hygiene device is sterilized after being used and then reused.
